(19) United States
(12) Patent Application Publication
(10) Pub. No.: US 2015/0150198 A1
(43) Pub. Date: Jun. 4, 2015

(54) Multi-Tiered Rack System for Growing Crops and Plants

(71) Applicant: Pratik SINHA, (US)

(72) Inventor: Pratik Sinha, Abu Dhabi (AE)

(21) Appl. No.: 14/400,357

(22) PCT Filed: May 1, 2013
(86) PCT No.: PCT/IB2013/000808

§ 371 Date: Nov. 11, 2014

Related U.S. Application Data
(60) Provisional application No. 61/777,622, filed on Mar. 12, 2013.

(51) Int. Cl. A01G 9/02; A01G 27/00

(52) U.S. Cl. CPC A01G 9/023; A01G 27/00

(57) ABSTRACT

A rack system for growing crops includes a first stand, a second stand, and a base supporting the first and second stands. At least one tray holder is positioned on each of the first and second stands, and at least one rack tray has a plurality of attachment points at opposite ends of the at least one rack tray. The attachment points allow the at least one rack tray to tilt to a plurality of predetermined angles. The rack can be pre-fabricated or composed of multiple independent pieces. The trays tilt to various calibrated angles and provide a maximum amount of light on the trays. Further, the rack system can have various attachments and can be optionally setup in a controlled environment. The rack system can be set up over existing arable land or in un-utilized locations where irrigation is sourced from below a body of water.

### CROSS REFERENCE TO RELATED APPLICATIONS

This application claims the benefit of the U.S. Provisional Application No. 61/777,622, filed Mar. 12, 2013, which is herein incorporated by reference as if expressly set forth in its entirety.

### BACKGROUND

1. Technical Field

The subject matter disclosed herein relates generally to an agricultural crop growing rack system using vertically placed multi-tiered rack trays. In one embodiment, the multi-tiered rack trays are positioned in step-up ladder formation and adjusted to angles for maximum light coverage, to form a rack system for cultivating/growing plants and crops.

2. Description of Related Art

Hydroponic plant growing racks for various types of plants are known. Hydroponic assemblies have been used to sprout and cultivate plants, including vegetables, flowering plants, and novelty plants such as Venus-Fly-Traps, among others, in a soil-less environment. However, hydroponics is for a soil-less culture.

A typical hydroponic plant growth system comprises a nutrient base and circulates a liquid nutrient through a cultivation portion wherein the plant seeds or young plants are anchored. For example, U.S. Pat. No. 5,502,923 discloses a hydroponic plant growth system which consists of a nutrient supply module base which supplies liquid nutrient to a series of vertically stacked prop modules, each prop module containing a number of plant growth sites. As liquid nutrient is pumped to each prop module, water is distributed to the plants grown therein.

Similarly, U.S. Pat. Nos. 4,033,072, 5,440,836, 5,555,676 and 5,918,416 disclose vertical growing columns for growing a number of plants which are supplied with water and nutrients through the use of nutrient solution pumps in the base of the respective apparatuses, which supply liquid nutrient to the top of the apparatuses. The liquid nutrient is supplied to the plants as the liquid travels from the top of the apparatuses to the bases.

Further, the above references indicate that multiple vertical plant grow columns may utilize a single nutrient base. For example, U.S. Pat. No. 5,363,594 discloses a structure for a vertically oriented plant growth unit having a plurality of vertical columns arranged to conserve horizontal floor space and utilize a common base for the supply of liquid.

U.S. Pat. No. 2,764,845 is directed to a planter that consists of pairs of similarly formed and interchangeable wall sections of knockdown construction adapted to be assembled to form a receptacle or box adapted to receive plants or the like, and a support structure therefore.

U.S. Pat. No. 5,440,836 is directed to a hydroponic device that includes a U.S. Pat. No. 5,896,701 is directed to a hydroponic cultivation receptacle comprising a tray having a board upon which to place seeds of small vegetables like sprouts.

However, an issue with the above devices and method of growing plants is the amount of area and expertise/equipment that is required. In most instances, a completely separate building is required with light and temperature control as well as containers for holding the plants and the nutrient solutions. This can be costly for start-ups and requires expertise, monitoring, etc. and may not be practical for large scale commercial utilization. The cost and expertise requirement can severely limit the people who can participate. Moreover, most of this type of growing will take place in cities or gardens or highly populated areas where there is insufficient area for standard or commercial farming techniques and, thus, limited area for the installation of normal hydroponic type growing systems or for devices to commercially grow plants in soil.

Another problem with the above devices is proper lighting. In many of above plant growth units, different types and amounts of light may be received by plants in different positions. The differences in light quality and quantity may result in a divergence in growth and quality between plants grown at various levels and on various sides of the plant growth units.

Also, the racks in the above described devices cannot be adjusted to a variety of angles or adjusted to hold trays with plants/crops in the soil at a variety of angles. Traditional racks are sophisticated set ups and not always free standing with the ability to attach additional racks to increase the holding capacity or have low cost alternatives. In addition, traditional racks do not have changeable angled positions, which allow for an increase of the light source on each tray. Prior art racks cannot be disassembled to be easily stored or shipped, nor can they be easily transported to other locations. The prior racks are also not designed for setting up on slopes, rocky mountainous or unutilized surfaces, or come in pre-fabricated structures. The prior racks are not specifically designed to set up over existing arable land which can continue to be utilized to grow plants or optionally converted to water bodies for pisciculture or to cultivate edible plants and animals.

Additionally, the above devices include complex irrigation mechanism with primarily nutrient solutions. Accordingly, the present subject matter optionally provides a simpler irrigation mechanism that delivers the water or water with soluble nutrients to the trays.

The prior devices are not specifically made for set up over unutilized areas like water bodies or non-arable land or rock surfaces or walls, etc. The apparatus of the present subject matter is easily and optionally setup over such unutilized area so as to increase the available cropping area.

The prior devices are not towable, resulting in damages and crop loss during unfavorable natural events or calamities. The present rack system is optionally towable to safer areas during such occurrences.

Accordingly, there is a need for an apparatus, system and method for soil based cultivation to address the above deficiencies. Other prior art systems can be found in the following non-exclusive list of references:

U.S. Patent Documents

| | | |
|---|---|---|
| 4,952,511 | August 1990 | Radmer |
| 4,986,027 | January 1991 | Harvey |
| 5,201,860 | April 1993 | Richardson |
| 5,217,696 | June 1993 | Wolverton et al. |
| 5,265,376 | November 1993 | Less |
| 5,276,997 | January 1994 | Swearengin et al. |
| 5,305,551 | April 1994 | Orlov |
| 5,363,594 | November 1994 | Davis |
| 5,381,625 | January 1995 | Wente |
| 5,440,836 | August 1995 | Lee |
| 5,502,923 | April 1996 | Bradshaw |
| 5,515,648 | May 1996 | Sparkes |
| 5,555,676 | September 1996 | Lund |
| 5,577,344 | November 1996 | Zaremba et al. |
| 5,683,762 | November 1997 | Banschick |
| 5,918,416 | July 1999 | Ammann, Jr. |
| 6,098,338 | August 2000 | Tilton |
| 6,178,692 | January 2001 | Graven |
| 6,230,437 | May 2001 | Wolverton et al. |
| 6,477,805 | November 2002 | Ware |
| 4,928,426 | May 1990 | Janssens |
| 6,453,610 | September 2002 | Tonkin et al. |
| 6,615,537 | September 2003 | Tonkin et al. |
| 7,166,224 | January 2007 | Tonkin et al. |
| 2005/0166451 | August 2005 | Stachnik |
| 2006/0117656 | June 2006 | Graham et al. |

### OTHER REFERENCES

International Search Report, dated Apr. 6, 2004, for corresponding PCT/JP2004/000319.
Youeki Saibai No Shin Manyuaru, “New Manual for Nutrient Fluid Cultivations” edited by the Japan Greenhouse Horticulture Association, issued by Seibundo Shinkosha Inc., in July 2002 (On Order).
Saibai, Y., et al., “New Manual for Nutrient Fluid Cultivations”, edited by the Japan Greenhouse Horticulture Association, issued by Seibundo Shinkosha Inc., in July 2002 (previously listed as “On Order”).

English translation of pertinent portion of “New Manual for Nutrient Fluid Cultivations”, listed above, p. 34, lines 10-26 and p. 33, FIGS. 3-2-1, 3-2-2 and 3-2-3.

### BRIEF SUMMARY

The subject matter disclosed herein recognizes the deficiencies of the discussed above and provides solutions to one or more of the existing deficiencies. In particular, disclosed is a rack system for growing crops, comprising: a first stand and a second stand; a base supporting the first stand and the second stand, the first stand arranged opposite the second stand; at least one tray holder positioned on each of the first and second stands; at least one rack tray comprising a plurality of attachment points at opposite ends of the at least one rack tray, the attachment points configured for tilting the at least one rack tray to a plurality of predetermined angles; and attachment means attaching the at least one rack tray to the at least one tray holder through the attachment points.

The rack system for growing crops, may also be described as comprising: a first inverted V-stand and a second inverted V-stand, the first and second inverted V-stands each comprising a diagonal support and a substantially vertical support; a base supporting the first inverted V-stand and the second inverted V-stand, the first inverted V-stand arranged at an end opposite the second inverted V-stand; at least one tray holder extending between the diagonal support of the first inverted V-stand and the diagonal support of the second inverted V-stand; at least one growing rack tray comprising a plurality of tilting notches at opposing ends; at least a pair of anchor hooks attached to at least one of the tilting notches at each opposing end of the at least one elongated growing rack tray; and at least a pair of hangers, each comprising an anchor attachment and a hanger hook, each of the anchor attachments attached to the anchor hooks and each of the hanger hooks suspending the at least one growing rack tray from the at least one tray holder, wherein the plurality of tilting notches at the opposing ends of the at least one growing rack tray are configured to tilt the at least one growing rack tray to a plurality of predetermined angles.

Also disclosed is a method of growing crops, comprising: providing a rack system for growing the crops, the rack system comprising: a first stand, a second stand, a base, and at least one tray holder positioned on each of the first and second stands, wherein the base supports the first stand opposite the second stand; providing at least one rack tray, the at least one rack tray comprising a plurality of attachment points at opposite ends of the at least one rack tray, the attachment points configured for tilting the at least one rack tray to a plurality of predetermined angles; attaching the at least one rack tray to the at least one tray holder by way of attachment means; and tilting the at least one rack tray to a predetermined angle to provide additional sunlight to the rack tray.

### BRIEF DESCRIPTION OF THE DRAWINGS

Many aspects of the disclosure can be better understood with reference to the following drawings, wherein:

FIG. 1 is a front perspective view of an embodiment of a rack system for growing crops;

FIG. 2 is a front perspective view of the growing rack tray and hangers attached to the growing rack tray;

FIG. 3 is a detailed perspective view of the growing rack tray, showing attachment points configured for tilting the growing rack tray to predetermined angles and attachment means;

FIG. 4 is a rear perspective view of the growing rack tray with attachments for irrigation;

FIGS. 5A-C show views of the growing rack tray positioned in a plurality of predetermined angles;

FIG. 6 is a perspective view of the growing rack tray, showing exemplary measurements and attachment points for titling the growing rack tray to predetermined angles;

FIG. 7 is a side view of the rack system, showing crops in the growing rack trays suspended from stands of the rack system;

FIG. 8 is a side view of another exemplary embodiment of the rack system with multiple hangers and attachment points;

FIG. 9 is a perspective view of another exemplary embodiment of the rack system with side rods for hanging the growing rack tray;

FIG. 10 is a side view of another exemplary embodiment of the rack system with side rods at a predetermined angle and hooks or slide in, etc attachments;

FIG. 11 is a side view of another exemplary embodiment of the rack system with side rods at a predetermined angle and the growing rack tray having clips;

FIG. 12 shows another embodiment of the rack system, where the stands are assembled from independent pieces configured to fit together;

FIG. 13 is a detail view of exemplary embodiments of fittings of the independent pieces;

FIG. 14 is a side view of a rack system with five growing rack trays and wheels, and exemplary measurements of the stands and base of the rack system;

FIG. 15 shows multiple rack systems placed together over land, along with an irrigation system;

FIG. 16 show three rack systems arranged in and around a body of water and surrounding land;

FIG. 17 shows three rack systems, with an irrigation system, arranged over a body of water, allowing for growing crops and pisciculture;

FIG. 18 shows four rack systems arranged in pairs, allowing sprinklers to provide water to the crops growing therein;

FIG. 19 is a detail view of an exemplary embodiment of the irrigation system;

FIG. 20 shows two rows of four rack systems positioned within a surrounding greenhouse frame;

FIG. 21 shows an embodiment of the rack system implemented over a mountainous or other uncultivable area;

FIG. 22 shows an embodiment of the rack system implemented over an urban structure or unutilized space; and

FIG. 23 shows six rack systems with sprinklers, arranged on a body of water used for pisciculture or edible plants and animals, where the water body is the source of sprinkler irrigation.

### DETAILED DESCRIPTION

Reference is now made in detail to the description of embodiments as illustrated in the drawings. While the embodiments described may use specific materials or configurations, there is no intent to limit the subject matter to the embodiment or embodiments disclosed herein. Accordingly, various modifications to the embodiments presented may be readily apparent to those skilled in the art, and the generic principles described herein can be applied to other embodiments without departing from the spirit or scope of the claimed subject matter. As such, this detailed description of various alternative embodiments should not be construed to limit the scope or breadth of the present apparatus, system and method as set forth in the claims.

The method for growing crops comprises: (a) providing a vertical arrangement of tilted or horizontal multi-tiered rack system with trays capable of being positioned or angled to provide maximum light to each tray; (b) providing optional overhead irrigation pipes from holding tanks at height, utilizing gravitation flow or pump flow and smaller pipes with pre-determined spacing for covering water availability in trays; and (c) placing multiple rack systems in rows and columns to create a multi-tiered agriculture cropping field or the rack system placed over unutilized or non-arable area and water bodies.

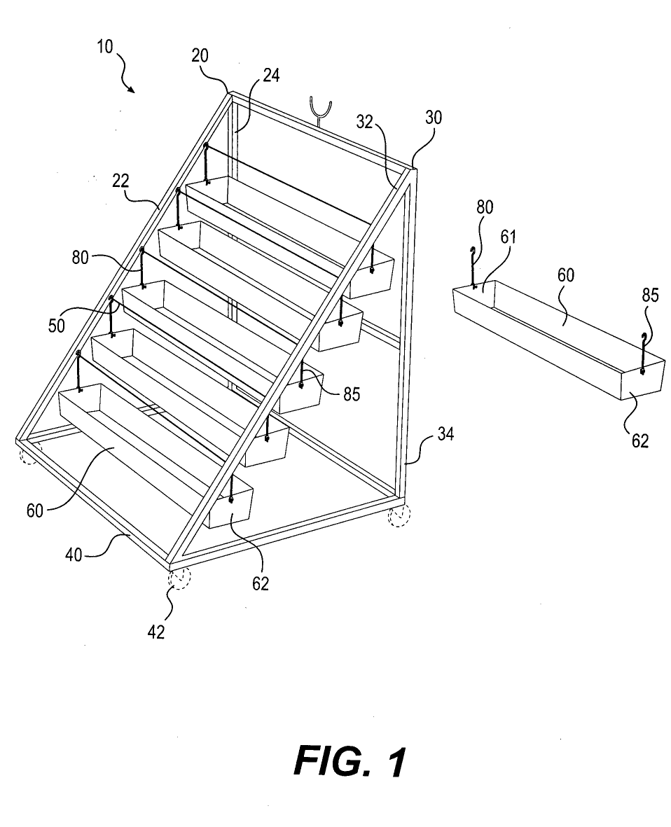

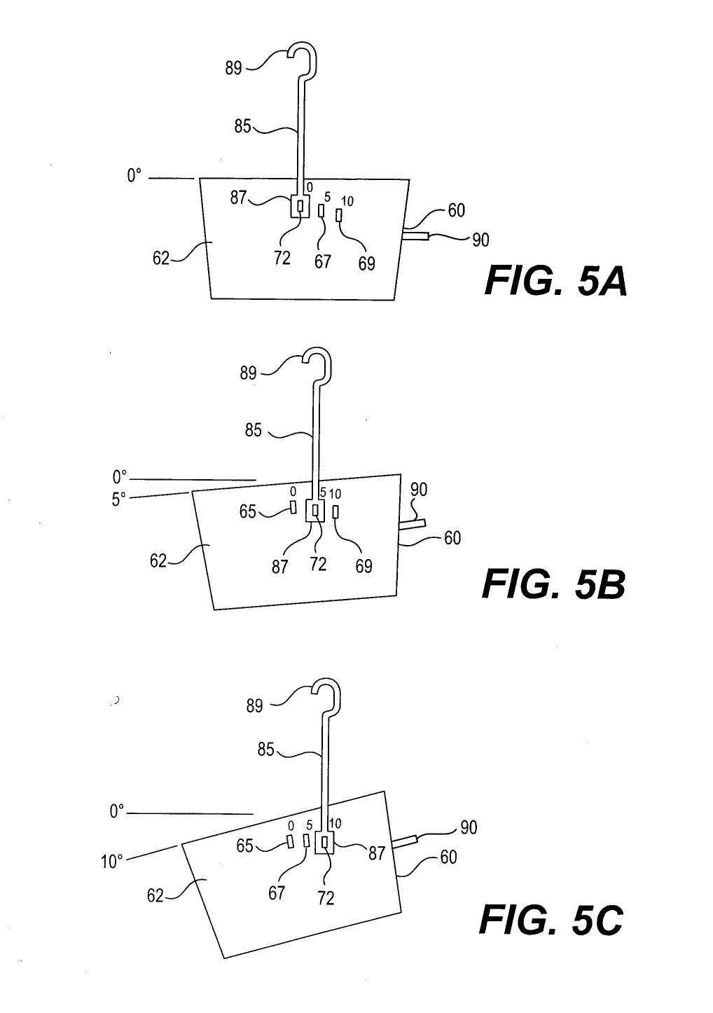

Turning now to the non-limiting embodiments depicted in the figures, FIG. 1 is a front perspective view of an embodiment of a rack system 10 for growing crops 12 (see e.g., FIG. 5). The rack system 10 includes a first stand 20 and a second stand 30. As shown, the first stand 20 and the second stand 30 are each configured as an inverted V. Accordingly, the first stand 20 comprises a diagonal support 22 and a substantially vertical support 24, and the second stand 30 comprises a diagonal support 32 and a substantially vertical support 34, thus forming the inverted V. The first and second stands 20, 30 are supported by a base 40. The base 40 is shown as substantially rectangular or square, having two pairs of opposing sides. However, other configurations and shapes for base 40 could be used depending on the specific application.

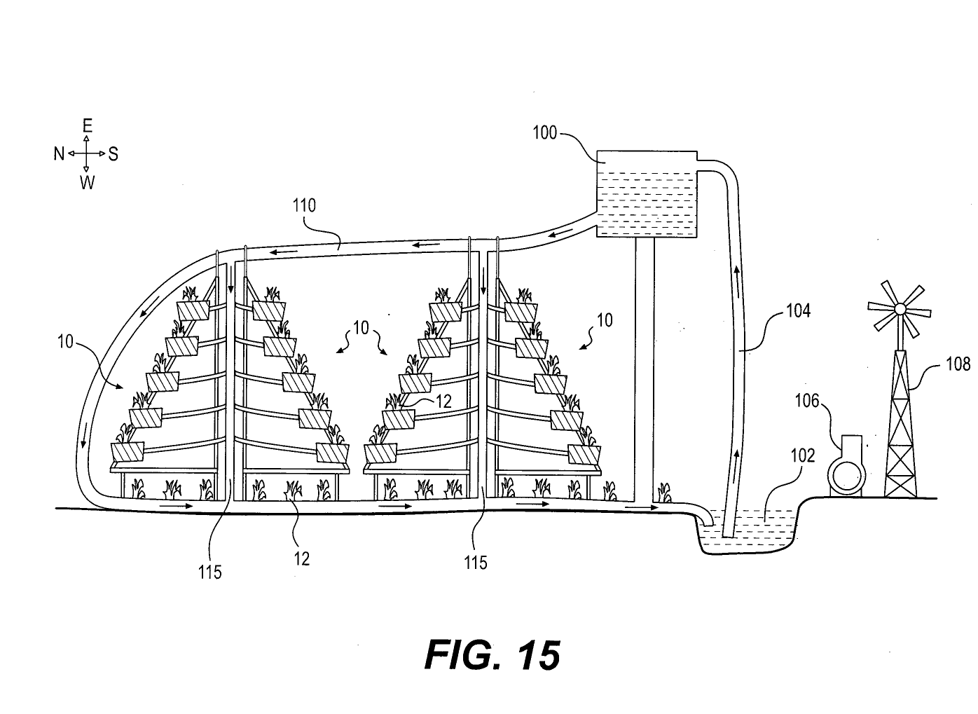

The first and second stands 20, 30 are arranged opposite each other and portions of the first and second stands 20, 30 spaced apart (that is, a bottom of the inverted V) are attached to opposing sides, or corners, of the base 40. While this configuration of the first and second stands 20, 30 and the base 40 provides sufficient support for the rack system 10, additional cross-members extending from the substantially vertical support 24 of the first stand 20 and the substantially vertical support 34 of the second stand 30 can also be included. Additionally, the base 40 is shown with wheels 42, which while optional, can facilitate movement of the rack system, in particular for towing or arranging the rack system 10 in an East-West direction for optimum sunlight exposure (as will be discussed in more detailed with respect to FIGS. 15-17).

Extending between the diagonal support 22 of the first stand 20 and the diagonal support 34 of the second stand 30 is at least one tray holder 50. As shown in FIG. 1, the tray holder 50 is a center bar extending between the diagonal supports 24, 34. While FIG. 1 shows the tray holder 50 as a center bar, it is also envisioned that alternative embodiments of the tray holder 50 could be employed, for example, separate and independent attachment points, hooks or notches located on each of the diagonal supports 24, 34. In addition, while FIG. 1 depicts five (5) tray holders 50, it is understood that any number of tray holders 50 could be used.

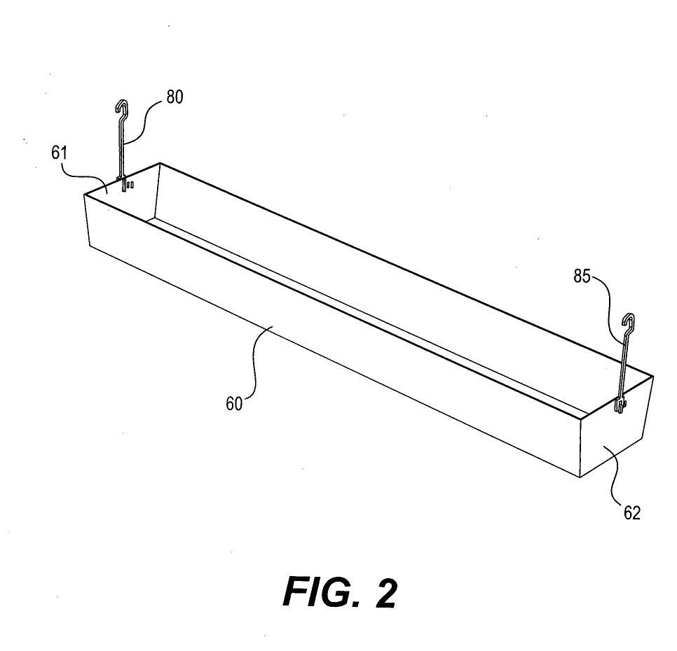

The tray holder 50 holds, or supports or attaches to, at least one growing rack tray 60 by way of attachment means, which are shown as hangers 80, 85. As shown in FIG. 2, the growing rack tray 60 is an elongated rack tray having opposing ends 61, 62, or more specifically, a first end 61 and a second end 62. The hangers 80, 85 attach to the opposing ends 61, 62 of the growing rack tray 60, and to the tray holder 50 of the diagonal members 24, 34 of the first and second stands 20, 30.

As a low-cost non-limiting method, bamboo or wooden sticks or ropes can be utilized to create the rack system 10, in particular the first and second stands 20, 30, and the growing rack trays 60 can be selected from the group comprising wooden crates, bamboo baskets, open weave baskets, earthenware, treated rubber, plastic sheets, and combinations thereof. The growing rack trays 60 may be pre-filled with soil, seeds and/or planted seedlings (with or without nutrients or organic manure/peat moss/etc.) before uploaded into rack system 10. In case of rack system 10 positioned on high, workers may use a common step up ladder or small boats (if set up over water bodies) to tend to plants in trays and to harvest.

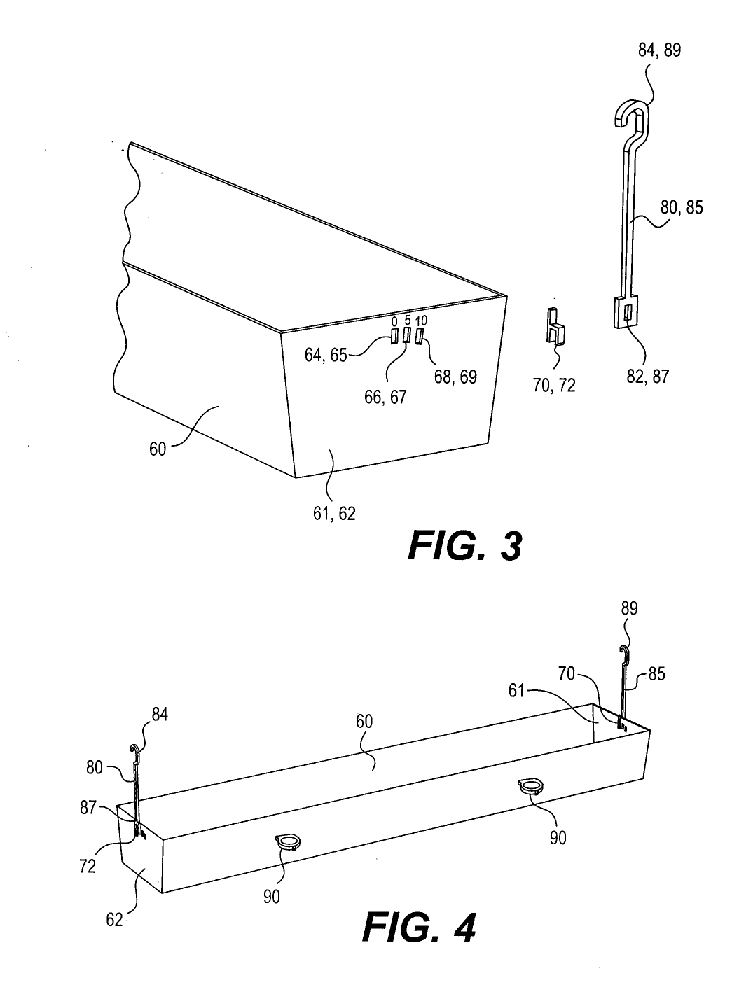

The growing rack tray 60 is shown in further detail in FIG. 3. For convenience, FIG. 3 is shown and described with both the first and second ends 61, 62 of the growing rack tray 60 substantially mirroring each other. As shown, there is a plurality of attachment points 64, 66, 68 located on the first end 61 of the growing rack tray 60, with corresponding attachment points 65, 67, 69 being located on the second end 62 of the growing rack tray 60. In FIG. 3, the plurality of attachment points 64-69 are shown as notches in the respective first and second ends 61, 62 of the growing rack tray 60.

In this non-limiting embodiment, at least a pair of anchor hooks 70, 72 are provided. Anchor hooks 70, 72 are configured to engage through at least one of the notches or attachment points 64-69 on the respective opposing ends 61, 62 of the growing rack tray 60. A back of the anchor hooks 70, 72 prevents the anchor hooks 70, 72 from passing through the notches. This allows a hook portion of the anchor hooks 70, 72 to protrude through first and second ends 61, 62 of the at least one rack tray 60.

This embodiment further provides a pair of hangers 80, 85 to hang or suspend the growing rack tray 60 from the tray holder 50. The hangers 80, 85 have an attachment end 82, 87 and a hook end 84, 89. The attachment end 82, 87 of each of the hangers 80, 85 is configured to attach to, or engage, the protruding portion of the anchor hooks 70, 72. As shown, the attachment end 82, 87 is represented as an open rectangle; however, alternative embodiments capable forming a tight connection are envisioned, such as threaded connections or other geometric shapes.

The hook ends 84, 89 of the hangers attach to or hang from the one tray holder 50 and the attachment ends 82, 87 are attached to the protruding portions of the anchor hooks 70, 72. In order to maximize sunlight exposure to crops 12 in the growing rack tray 60, the attachment points 64-69 provided are arranged such that the growing rack tray 60 can be tilted to a plurality of predetermined angles. In particular, a first tilting notch 64, with a corresponding first tiling notch 65 being located on the opposing end 62, is show as being zero (0) degrees. Thus, when the anchor hooks 70, 72 are engaged with the first tilting notches 64, 65, the growing rack tray 60 is suspended or hanging such that the at least one rack tray 60 is level, or at zero (0) degrees.

Also provided is a second tilting notch 66, with a corresponding second tilting notch 67 being located on the opposing end 62, which is shown as being at five (5) degrees. When the anchor hooks 70, 72 are engaged with the second tilting notches 66, 67, the growing rack tray 60 is suspended or hanging such that the growing rack tray 60 is tilted at a five (5) degree angle from vertical. FIG. 3 further shows a third tilting notch 68, with a corresponding third tilting notch 69 being located on the opposing end 62, which is shown as being at ten (10) degrees. This allows the growing rack tray 60 to be tilted at ten (10) degrees from vertical. While FIG. 3 shows tilting angles of zero (0), five (5) and ten (10) degrees, these predetermined angles are provided as exemplary only, and it is fully intended that the rack system 10 could be configured with any number of predetermined angles.

Additionally, as shown in FIG. 3, the tilting notches 64-69, or attachment points, are positioned towards a top of the first and second ends 61, 62 of the at least one growing rack tray 60. This configuration allows the at least one growing rack tray 60 to hang at the desired predetermined angle for maximizing sunlight exposure. Additionally, when the growing rack tray 60 is filled with crops 12 and soil, the weight of the growing rack tray will serve to prevent rotation, as the center of gravity of the growing rack tray 60 and contents thereof is lower than the tilting notches 64-69.

The anchor hooks 70, 72 can be tightly fitted to the attachment end 82, 87 of the hanger 80, 85 in order to prevent rotation of the growing rack tray 60 in the event that the growing rack tray 60 becomes unbalanced. Additionally, where the configuration of the anchor hook 70, 72 and the attachment end 82, 87 of the hanger 80, 85 is rectangular or similar geometric shape, rotation is further prevented.

Furthermore, it is envisioned that the attachment points 64-69 may comprise protrusions protruding from the opposing ends 61, 62 of the growing rack tray 60, or holes in the opposing ends 61, 62. Accordingly, such a configuration would allow the attachment means, shown as hangers 80, 85, to attach directly to the points protruding from the opposing ends 61, 62. It is further contemplated that other means for attaching the hangers 80, 85 to the opposing ends 61, 62 of the at least one growing rack tray 60 could be used, for example a nut and bolt combination or other fastening means.

Additionally, the configuration of the tilting notches 64-69 allows the rack system 10 for growing crops 12 to be placed on surfaces that are not flat, yet still allow for tilting the growing rack trays 60 to a position to receive maximum sunlight exposure.

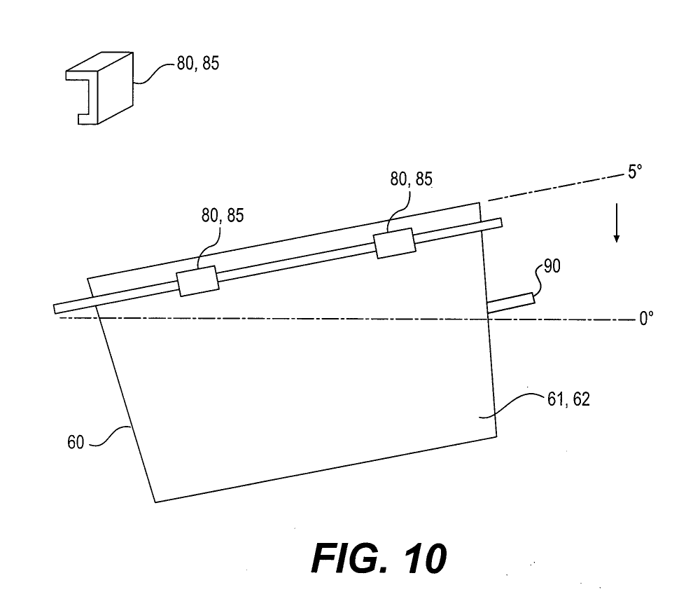

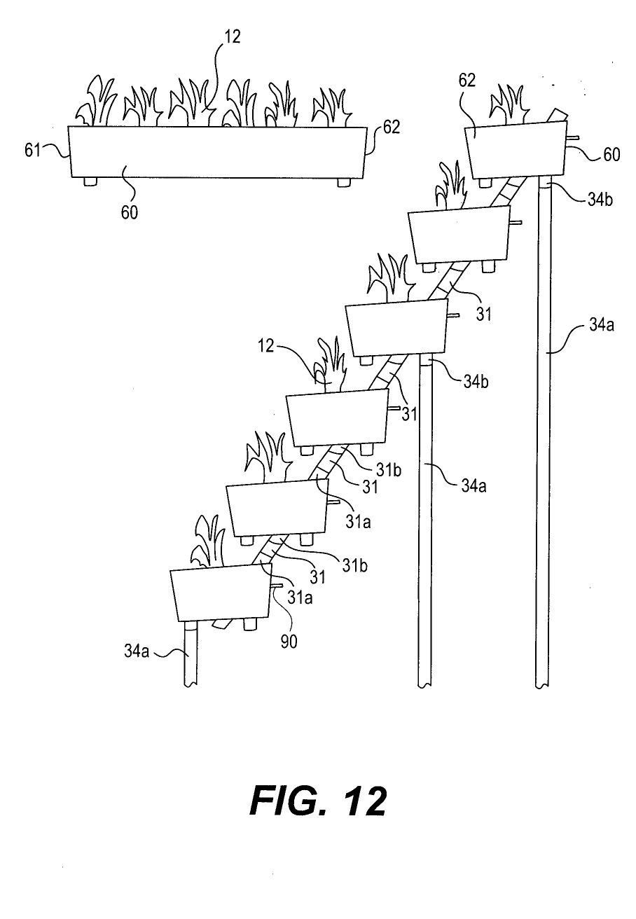

FIG. 4 shows a rear prospective view of the growing rack tray 60 and the hangers 80, 85 attached to the pair of anchor hooks 70, 72. The opposing ends 61, 62 are shown with a plurality of notches (not labeled for clarity) for tilting the growing rack tray 60. In the embodiment shown in FIG. 4, the growing rack tray 60 further comprises optional attachments 90 for an irrigation system 100 (which will be explained in further detail with respect to FIGS. 10 and 12). The attachments 90 are not only configured to provide irrigation to the growing rack tray 60, but can also provide additional support to prevent rotation of the growing rack tray 60.

FIGS. 5A-C show views of the second side 62 of the growing rack tray 60 positioned in the plurality of predetermined angles. For brevity, views of the opposite side 61 are not shown, but would appear similar to FIGS. 5A-C. In FIG. 5A the growing rack tray 60 is suspended from the at least one tray holder 50 of the diagonal support 32 (not shown) by the hanger 85. The attachment end 87 of the hanger 85 is attached to the anchor hook 72, which is positioned in the first tilting notch 65. In this configuration, the growing rack tray 60 is tilted at zero (0) degrees (in other words, the growing rack tray 60 is not tilted, but level). In FIG. 5B, the anchor hook 72 is positioned in the second tilting notch 67 and attached to the attachment end 87 of the hanger 85. In this configuration, the growing rack tray 60 is tilted at five (5) degrees. In FIG. 5C, the anchor hook 72 is positioned in the third tilting notch 69 and attached to the attachment end 87 of the hanger 85. In this configuration, the growing rack tray 60 is tilted at ten (10) degrees. While particular values (i.e., zero (0), five (5) and ten (10) degrees) are specifically disclosed, it is contemplated that the plurality of predetermined angles may comprise any number and value of predetermined angles. Accordingly the scope of this disclosure should not be limited by the specific examples provided herein.

While the attachment points are shown as first, second and third tilting notches 64-69, it is also contemplated that the attachment points can also include hooks, slots or pegs on the opposing ends 61, 62 of the growing rack tray 60. It is further contemplated that in lieu of anchor hooks 70, 72, the hangers 80, 85 could be fastened directly to the opposing ends 61, 62 with threaded fasteners, for example.

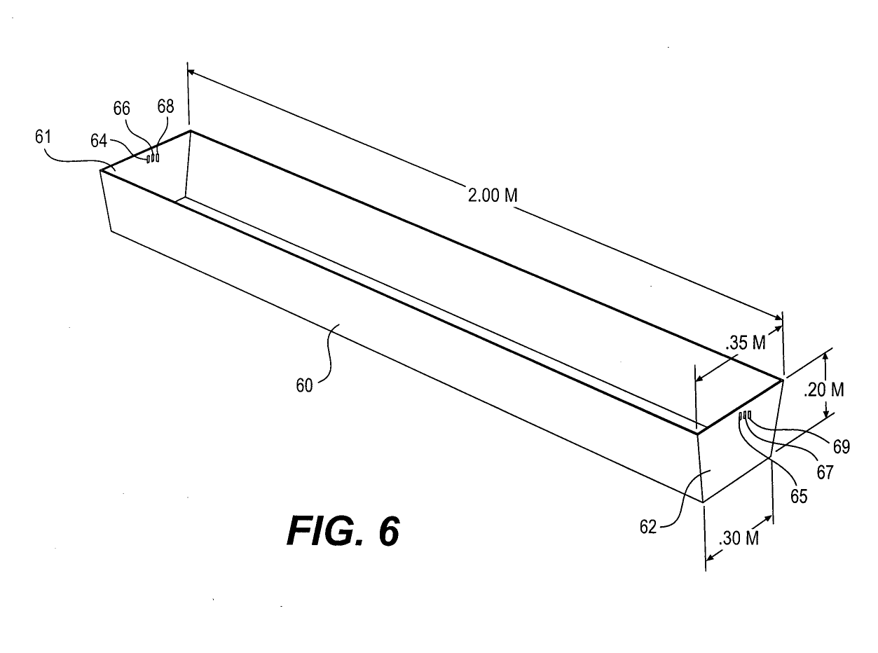

FIG. 6 shows exemplary dimensions of the growing rack tray 60. Depending on the growing rack tray 60 length, width and depth, various crop numbers may be grown in one tray to provide advantageous lighting and growing conditions to all the plants. For example, in the non-limiting embodiment of FIG. 6, a tray of dimension 2 m×0.3 m-0.35 m×0.2 m (length, width, height), four crop plants can be grown with horizontal spacing of 0.25 m space on either side. Thus, in this non-limiting embodiment, the first crop plant will be at 0.25 m from tray width side while the second crop plant will be at 0.50 m from the first plant, the third crop plant will be at 0.50 m from the second plant and the fourth crop plant will be 0.50 m from third crop plant and 0.25 m from the other side of the tray breadth.

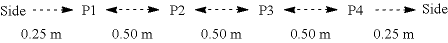

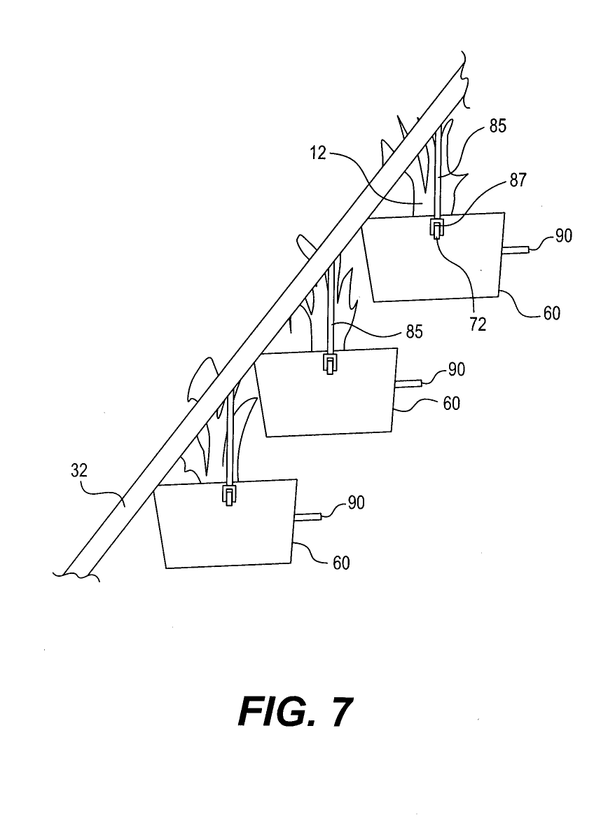

FIG. 7 shows a portion of a side view of the rack system 10 for growing crops 12. As shown, there are three growing rack trays 60, each of which suspended from the diagonal support 32 of the second stand 30 by means of the attachment end 87 of the hanger 85 attached to the protruding portion of the anchor hook 72. A view from the opposite side would show the opposing side 61 of the at least one growing rack tray 60, suspended from the diagonal support 22 of the first stand 20 by means of the hanger 85 attached to the protruding portion of the anchor hook 70. For clarity, the plurality of attachment points are not shown in FIG. 7.

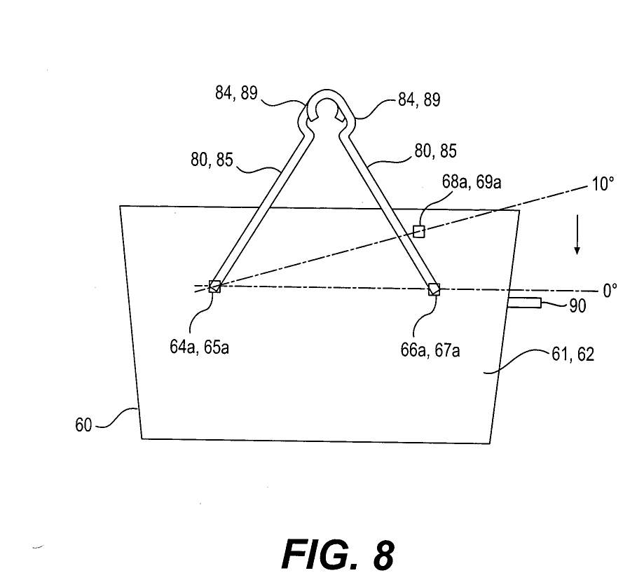

Shown in FIG. 8 is another embodiment of the growing rack tray 60, which is configured with a first titling notch 64a, 65a, a second tilting notch 66a, 67a, and a third tilting notch 68a, 69a, and at least a pair of hangers 80, 85 for each of the opposing sides 61, 62 of the growing rack tray 60. Each of the hook ends 84, 89 of the hangers 80, 85 hook to the at least one tray holder 50. The attachment ends 82, 87 (not shown in FIG. 8) of the hangers 80, 85 attach to, for example, the first tilting notch 64a, 65a and the second tilting notch 66a, 67a by way of anchor hooks 70, 72 position in the tilting notches 64a, 65a, 66a, 67a, for example. In this attachment manner, the growing rack tray 60 is tilted at zero (0) degrees (i.e., level). This configuration further provides additional support for preventing rotation of the growing rack tray 60, by providing support in the form of hangers 80, 85 to each of the opposing sides 61, 62 of the growing rack tray 60.

In the embodiment of FIG. 8, the growing rack tray 60 can be tilted at ten (10) degrees by attaching the attachment ends 82, 87 (not shown in FIG. 8) of the hangers 80, 85 to the first tilting notch 64a and the third tilting notch 68a. In this attachment manner, the third tilting notch 68a is at a higher location on the end 61 of the growing rack tray 60 than the first and second tilting notches 64a, 66a, thus the growing rack tray 60 will be tilted at, for example, ten (10) degrees. Additionally, while FIG. 8 shows first, second and third tilting notches 64a, 65a, 66a, 67a, 68a, 69a, it is contemplated that the opposing ends 61, 62 of the growing rack tray 60 can alternatively be one of the attachment points 64-69 as previously described.

Alternatively, it is contemplated that hangers 80, 85 of different sizes could be used to achieve the desired predetermined angle for maximum sunlight exposure (i.e., one hanger being longer than the other). If is further contemplates that the hangers 80, 85 could be adjustable in length in order to further facilitate obtaining the desired predetermined angle.

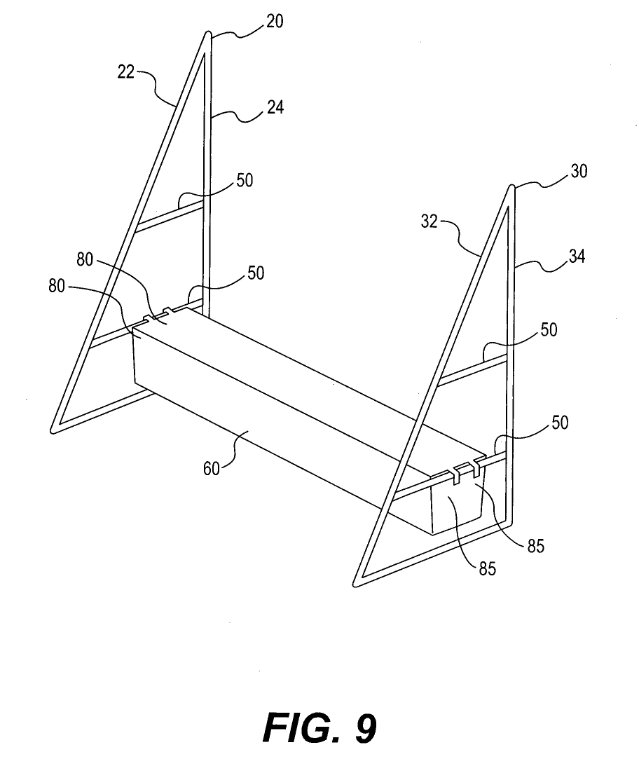

FIG. 9 shows a perspective view of another exemplary embodiment of the rack system 10 for growing crops. In this embodiment, the tray holder 50 is configured as a side rod extending from the diagonal support 22 to the substantially vertical support 34. In this embodiment, the growing rack tray 60 can attach or hook directly to the side rod, or tray holder 50. Additionally, there can be hangers 80, 85 directly on the growing rack tray 60, which hang on the tray holder 50. In particular, as shown in FIG. 9 and further detail in FIG. 10, there are a pair of hangers 80, 85 on each of the opposing sides 61, 62, wherein the hangers 80, 85, which are configured as hooks or clips, can slide into grooves in the side rods, the grooves preventing the hanger 80, 85 from sliding along the side rod. Additionally, the tray holder 50, configured as side rods can be horizontal or at a predetermined angle, such that the growing rack tray 60 is tilted at the predetermined angle in order to maximize sunlight exposure.

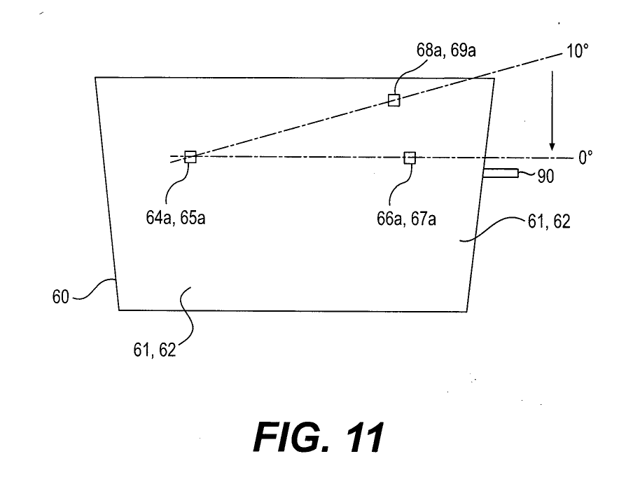

In addition, as shown in FIG. 11, the opposing sides 61, 62 of the growing rack tray 60 can be configured with the first tilting notch 64a, 65a, second tilting notch 66a, 67a, and third tilting notch 68a, 69a, in a similar configuration shown in FIG. 8. However, in this alternative embodiment, a pair of anchor hooks 70, 72 can be provided, and positioned in, for example, the first and second tilting notches 64a, 66a. The protruding portion of the anchor hooks 70 can then hang directly on the side rod, or tray holder 50, thus the growing rack tray 60 is not tilted, or at zero (0) degrees. If a ten (10) degree tilt was desired, the first and third tilting notches 64a, 68a could be used. Of course, the predetermined angles disclosed are merely exemplary, thus many different angles are considered within the scope of this disclosure.

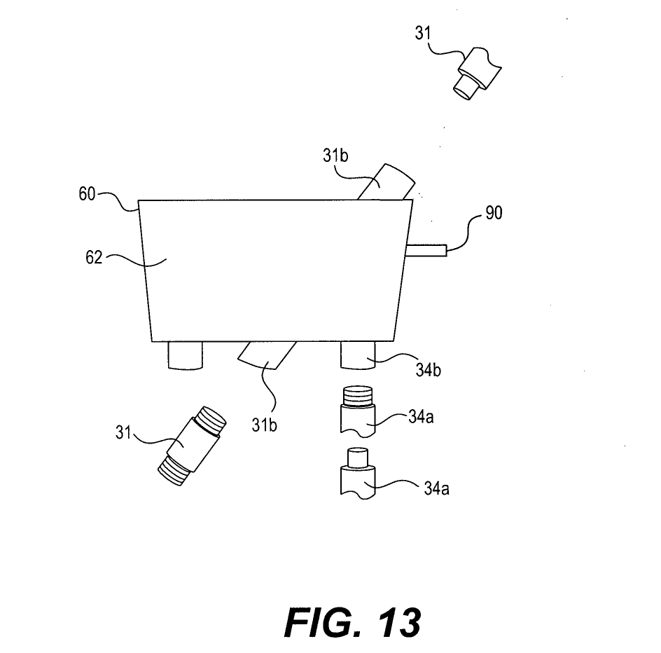

As shown in FIGS. 12-13, the rack system 10 can be composed of multiple independent pieces configured to easily fit or attach together. The independent pieces include fittings 31, 31a and 31b that are configured to fit together interchangeably with, for example vertical supports 34a of various heights, thus allowing a user to select a desired height, length and structure. Additionally, the independent pieces further allow the user to extend the size of the rack by linking in additional extension pieces or incorporating an entire additional rack system.

As a result of the independent pieces, the rack system 10 can be broken down to be shipped and stored in very small spaces, and available in assembly parts so that it can be easily dismantled and cheaply shipped all over the world for assembly and installation. The fittings 31, 31a, 31b are configured with threads, tapered ends, and openings, for example, such that the rack system 10 can be easily assembled, without requiring any sophisticated attachments or tools. Additionally, the independent pieces of the rack system 10 may slide together, fix into pre-fabricated holes or are attached together by various means such as threaded fasteners (e.g., screws/nuts/bolts) or other mechanisms, and fit firmly together to create a stable structure.

The materials for the rack system 10 can vary, from metals like aluminum (making it very durable, but also very light), plastic, treated rubber, alloys like stainless steel, or carbon fiber, or with low cost alternatives like bamboo, wood and rope. Many of these materials provide for excellent corrosion resistance, which can be an issue due to the continuous moisture created by plants. Further, various embodiments may also be implemented using a combination of the different materials disclosed or using different material for different piece.

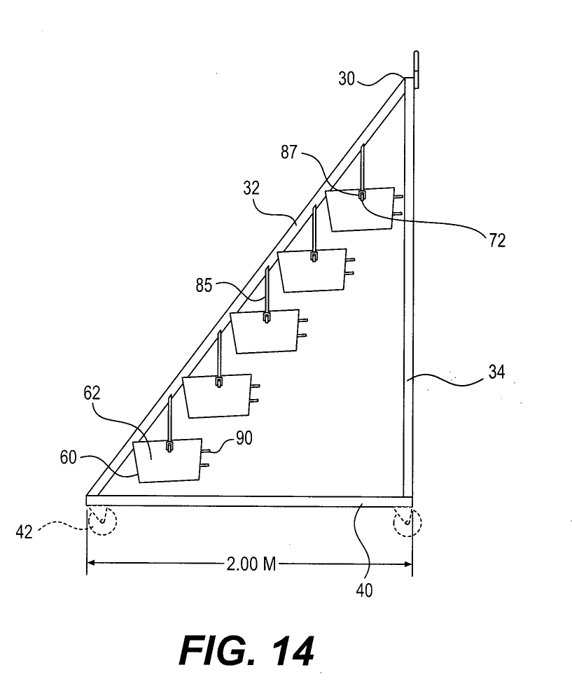

FIG. 14 shows a completed rack system 10 for growing crops. In this embodiment, there are five growing rack trays 60 arranged in a vertical multi-tiered arrangement and the base 40 is provided with an exemplary measurement of 2 meters. However, it is contemplated that the base 40 could comprise many different sizes. For brevity, reference to the remaining reference numerals is made above in discussion of previous figures.

Additionally shown are wheels 42, which, while optional, can further facilitate movement and positioning of the rack system 10. The wheels 42 provided with the rack system 10 allow rack system 10 to be towable by a vehicle in single or multiples (after attaching by rope, chain, etc.) and thus shifted to a safer location, in case of strong adverse weather conditions. Rack system 10 with motorable wheels and/or tires can be attached in a line and joined to vehicles and towable to safer places during natural calamity (e.g., thunderstorms, tsunami, tornadoes, cyclones, floods, etc.), especially where prior notice is available. Alternatively, the growing rack trays 60 can be removed and kept in a safer place for the duration of the natural calamity and then re-installed after the calamity has passed.

In addition to facilitating movement of the rack system 10 during a calamity, the wheels 42 optionally allow for the rack systems to be easily positioned in a desired position or direction. For example, it may be advantageous to position the rack system 10 in an East-West direction in order to maximize the sunlight exposure to the crops 12 in the growing rack trays 60. If the space available for the rack system 10 is not conducive for favorable direction placement, the rack system 10 can be attached with wheels 42 at the base 40 for easy maneuvering and to re-position the rack system towards favorable direction for maximum light availability to the growing rack trays 60 of the rack system 10.

The rack system 10 disclosed herein provides an efficient system that can grow a variety of commercially desirable crops in simple, compact, multi-tiered rack facilities, for example, as shown in FIG. 15. The rack system 10 can be used to grow a variety of crops, including vegetables, green leafy vegetables, herbs, medicinal plants, fruits and flowers. Depending on the depth of the growing rack tray 60, crops with shallow roots to larger root depths can be planted in the trays. If the rack system is setup on existing arable land, the small piece of land on which the rack system stands can be utilized for low sunlight requiring crops or shade requiring crops. For example, the rack system 10 can be set up over arable land and the land below can then be utilized for growing crops that may not require full sun (e.g., vegetables that will grow in full, dense shade or fairly constant dappled shade like salad greens (leaf lettuce, arugula, endive, and cress), broccoli, cauliflower, peas, beets, brussels sprouts, radishes, swiss chard, leafy greens (such as collards, mustard greens, spinach, and kale), beans, coriander, chilly, mint etc.). The arable land under the rack system can also be utilized for growing less intensive crops e.g. hardy forage crops that will not be very care intensive and will enrich the soil, besides providing food for animal stock.

As further shown in FIG. 15, multiple rack systems 10 are provided along with an irrigation system. The irrigation system can be rain fed or suitable for use with an automated watering system or a drip watering system. The rack system can be fitted with an overhead watering system that utilizes lifting of the water (pumping, rainwater harvesting, etc.) from ground level directly through pipes to the trays or to an overhead tank 100 and then letting the water into the racks for irrigation. FIG. 15 illustrates a non-limiting embodiment, which includes an automated drip watering system comprising a reservoir 102 with a pump 106 or windmill 108 for drawing water from a feed hose 104 or shaft and discharging the water through a plurality of individual drip hoses 116 leading to the individual growing rack trays 60 (see e.g., FIG. 19). Similarly, water pumped to an overhead tank positioned above the rack systems thus flows by gravity through conduit pipes 110 and 115, and gets distributed by manifold tubes 115a-d to individual drip hoses 116 spread across the individual growing rack trays 60 in the rack systems 10 (as further described with respect to FIG. 19). Alternately, other irrigation methods like sprinkler irrigation, moving overhead boom irrigation, or hand pump irrigation, etc. can also be utilized.

Where the irrigation system is through overhead tank 100 and pipes 110, 115, the water is raised from the reservoir 102 at ground level, thus the pump 106 or windmill 108 may be positioned in or near the reservoir 102 to pump the water into the overhead tank 100. The water in the reservoir can be mixed with nutrients before lifting or the mixing can be done in the overhead tanks. Manifold and distribution conduit pipes 115a-d, 116 with the pump 104 deliver the liquid to the crops 12 in the growing rack trays 60 and the delivery may include spray nozzles or drip irrigation associated with the plant for supplying liquid nutrient solution to roots of plants (see FIG. 19). In this scenario, the pump in liquid communication with the reservoir 102 and distribution conduits 110, 115 is so constructed and positioned to supply liquid nutrient solution from the reservoir 102 to at least roots of crops 12. The liquid communication may also utilize different heights of the rack systems 10 to allow liquid to flow from a higher to lower level. In case of uneven ground surface or for any other reason, if the conduit pipes cannot be arranged from high to low, then additional pumps can be utilized to allow liquid to flow through the entire length of conduit pipes. Generally, the pump may run continuously or at timed intervals to ensure sufficient liquid nutrient solution on the roots of the plants, depending at least in part on the construction or makeup of rack system, the rack numbers coupled together in the system, and the surrounding atmosphere.

Furthermore, the overhead irrigation system may or may not have rotating joints between overhead irrigation pipes and smaller pipes, to facilitate repositioning of the rack system, in particular where the rack systems 10 are provided with wheels 42 and repositioned periodically.

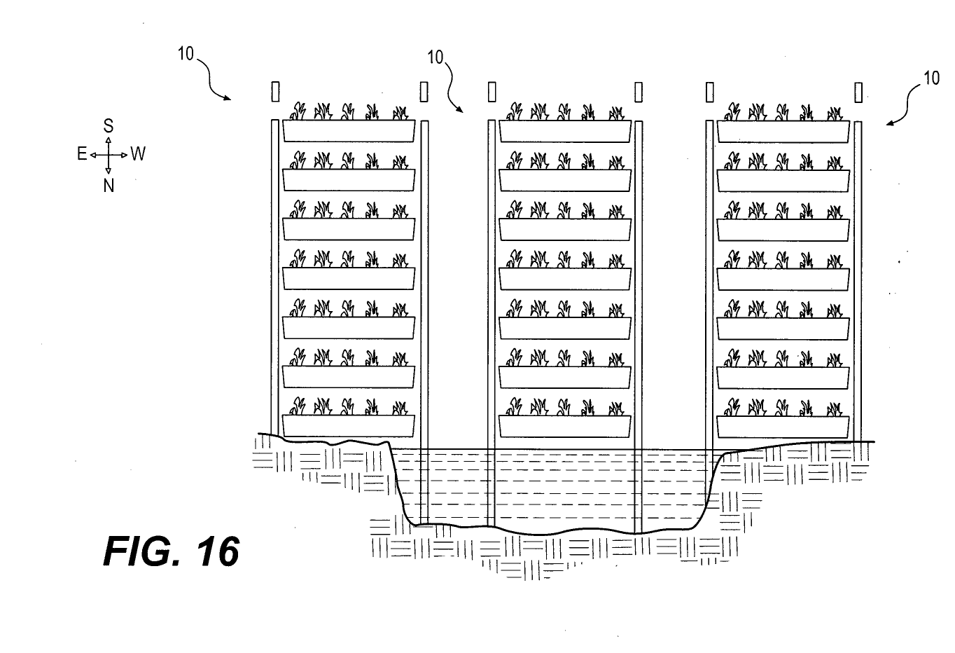

FIG. 16 shows three rack systems 10 arranged in and about a body of water. As shown, the outer two rack systems 10 are partially in the body of water and partially on land, and the middle rack system 10 is located entirely over the body of water. As such, space above and around a body of water that may have been previously unutilized, can now be utilized with one or more rack systems 10.

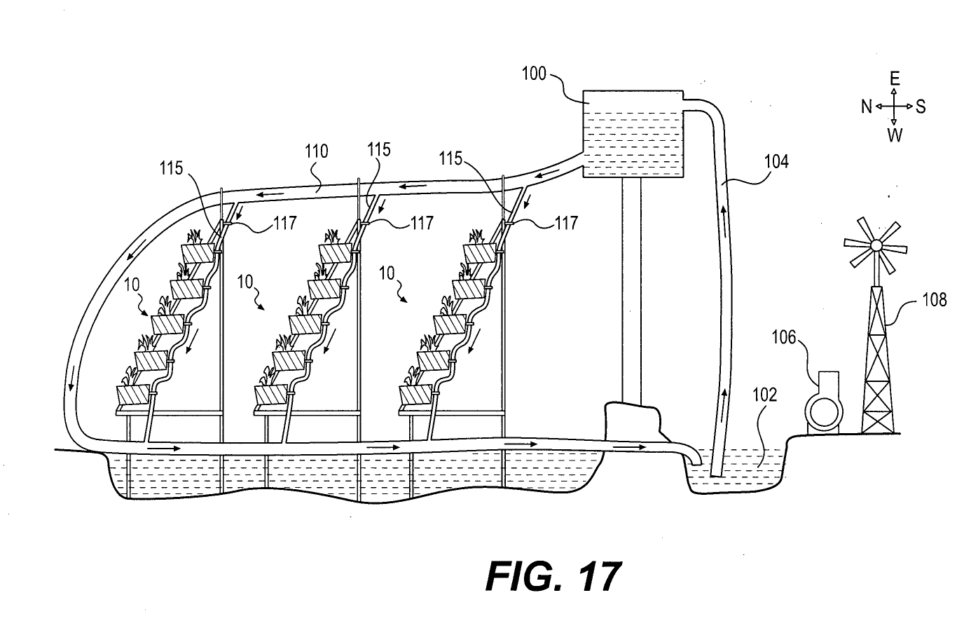

FIG. 17 shows three rack systems 10 arranged in a similar orientation as in FIG. 14; however in FIG. 17, the rack systems 10 and irrigation system is arranged about a reservoir 102 and another body of water. In such a scenario, the space above the body of water was previous not able to be cultivated, but as shown, the rack systems 10 can be configured to effectively utilize the space above the body of water.

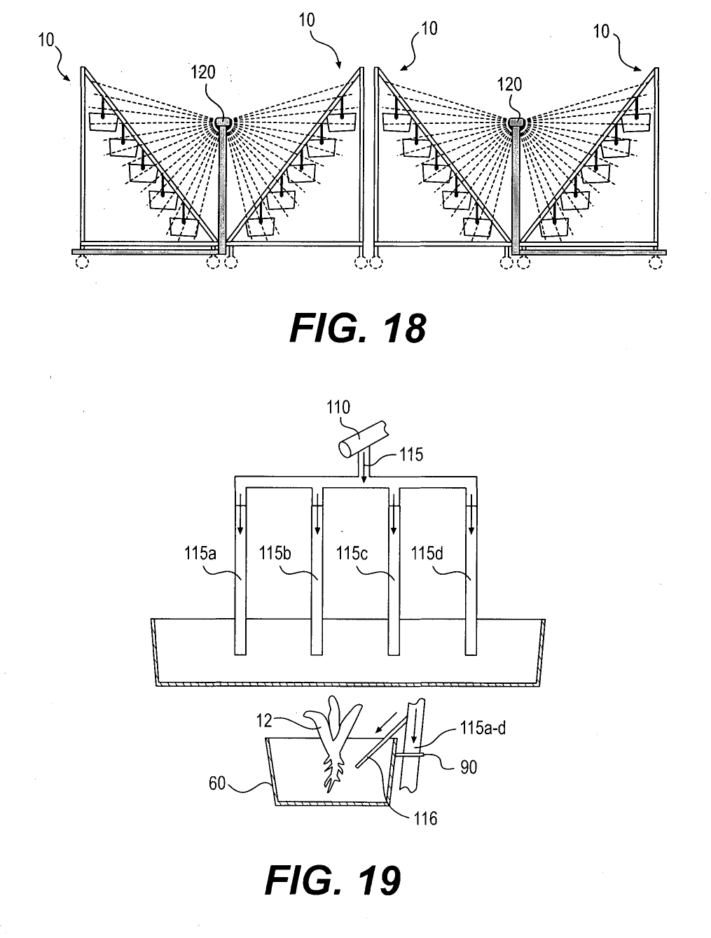

As mentioned above, other irrigation methods like sprinkler irrigation can also be utilized. Accordingly, FIG. 18 shows four rack systems 10 arranged in pairs, with sprinklers 120 to provide water to the crops 12 growing therein. Additionally, as shown, the rack systems 10 are provided with the optional wheels 42, which further allow the rack systems 10 to be moved. As such, the rack systems 10 can be moved to a location with sprinklers, rather than installing sprinklers at each location where the rack systems 10 are located. Further, the wheels allow for room beneath the base 40 of the rack systems 10, thus allowing for the hoses, pipes or conduits providing water, or water with nutrients, to the sprinklers 120.

FIG. 19 provides a detail view of the manifold for distributing water provided by the irrigation system. Water, with or without nutrients, is provided from the overhead tank 100 by the supply pipe 110 to distribution pipes 115 which extend vertically down the rack systems, and are attached to the growing rack tray 60 by, for example, a bolt or circular frame for the pipes to go through 90 (also shown in FIGS. 4 and 17). The water from the distribution pipes is further distributed by manifold tubes 115-a-d to individual drip hoses 116 spread across the individual growing rack trays 60 in the rack systems 10. Alternately, other irrigation methods like sprinkler irrigation, moving overhead boom irrigation, or hand pump irrigation, etc. can also be utilized.

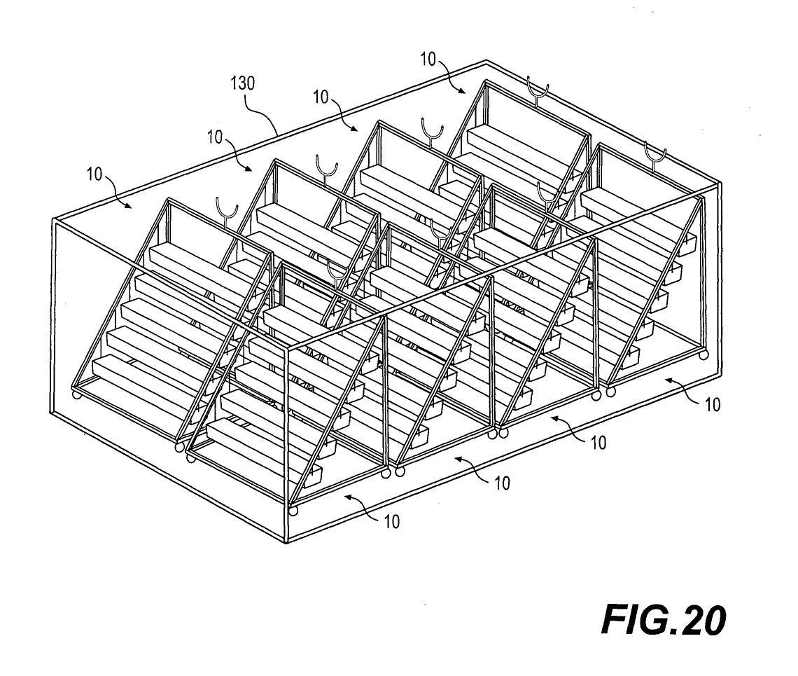

FIG. 20 shows an exemplary orientation of eight rack systems arranged in two rows, and positioned to form an agriculture cropping field, and optionally covered with plastic sheet, glass or other suitable material, and a corresponding supporting structure 130, to protect crops from adverse weather conditions, or to create greenhouse conditions for growing plants in a controlled setting using and controlling combinations of light, water, nutrition, and temperature to produce ideal growing conditions resulting in maximum possible plant growth and crop production.

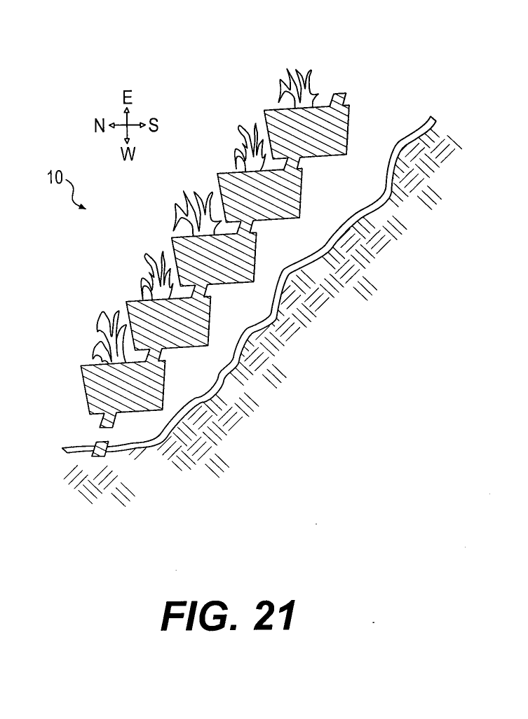

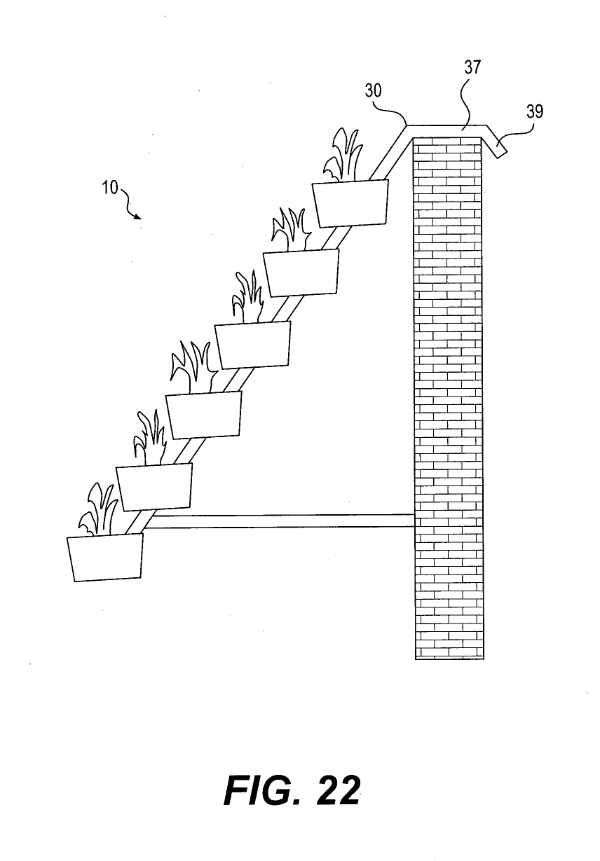

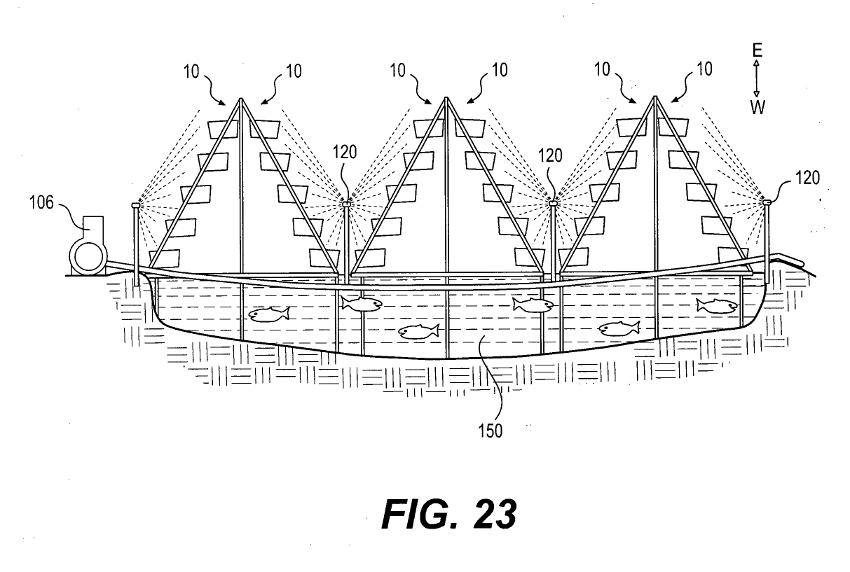

Shown in FIGS. 21-22 are rack systems 10 configured for installation over currently unutilized or wasteland, thus providing crop cultivation from areas which were previously not providing any farming opportunity, e.g. roof top, balconies in urban cities, over or on banks of rivers and ponds, lakes, rocky surfaces, fallow hills, arid/desert land, perimeter of walls, sides of buildings, sea shore/beaches, etc. The pre-fabricated or assembled racks can be configured for putting rack system on slopes and rocky surfaces, as the set up and retrieval is easier. In particular, as shown in FIG. 22, the rack system 10 can be configured where the first stand (not shown) and the second stand 30 further include a portion 37 for resting on top of a wall or existing urban structure, as well as a securing portion 39 to prevent the rack system 10 from falling.

The method of growing crops may further comprise, wherein the rack system can be set up over non arable areas like rocky land, arid land, waste land, terraces, river banks, sea shores, walls, balconies, etc, to provide for plant growing.

FIG. 22 shows a method of growing crops may further include a synergic utilization, creating open pits 150 from which the soil is utilized in the trays for plant growing, and the pits 150 are filled with water which can also be utilized for fish farming (pisciculture) or growing edible plants and animals in water, etc. The open pits 150 acts as water catchment from where water can be lifted to the overhead tanks 100 (see FIG. 17) and the irrigation system. Additionally, a plastic sheet can cover the rack system, such as in FIG. 20, while over water bodies and with the right humidity, the evaporation of water from catchment and condensation of water on the plastic sheets above or on the underside of rack above can provide irrigation water, without specific need for irrigation attachments.

In accordance with this disclosure, the rack system 10 for growing crops 12 may utilize a single growing rack with a tray or multiple growing racks with multiple trays supported by the frame system. The number or height of the racks may be changed based on the crops to be grown or number of growing trays required or the number of the growing trays the user wants to support. The overall height of one rack can be modified for each growing season depending on the desired use and the crop type cultivated e.g. lighter crops or smaller vegetables can allow for more/higher racks to be set up. The length and height of the racks can also be modified (length and height adjustable) to cater to different crop types.

The trays can be placed in desired direction and calibrated for tilting to various angles (e.g., five (5) degrees, etc) for maximizing light and space availability on the growing crops in the trays. Multiple cropping can be done in the trays, for optimizing yields.

Racks can be also be prefabricated with pre-defined tilted position and attached to other racks on top of one another but in a step up ladder structure. The tilting of the racks at suitable angle is to further increase the overall light received in each of the growing tray. The pre-fabricated racks can also be moldable/flexible to be fitted or shaped as per the shape of the below structure, especially rocky surfaces and mountain slopes, etc.

The rack system can be a constituent of an ecological solution utilizing existing or newer geographical areas. For example: a) the rack system can be set up on unutilized or rocky hill/mountain slopes where the irrigation water can be sourced through water catchment areas created on higher elevation or mountain tops with top down conduits delivering the water to the trays; and/or b) the rack system can be set up over water bodies (natural or man-made, river banks, sea shore, etc) with the water from the water body providing the irrigation water source and the excess of irrigation water flowing back to the water catchment from where irrigation water is being sourced. If the water is mixed with soluble fertilizer, nutrients, or additives which may pollute the water bodies below, excess water can be diverted to nearby plantations or recycled, etc, and it does not flow back to source.

The rack system can be setup on existing arable land with option of sourcing the crop growing soil for the racks from the land below and creating suitable dug up area or water bodies/ponds to hold water for pisciculture (fish farming, etc), growing edible plants and animals in water, etc, and for sourcing the irrigation water, thereby creating a self sustained model providing crop plus edible food source in water, where irrigation water can be sourced from below water bodies.

The disclosure provided herein fully describes the apparatus, system and method for growing crops in such clear and concise terms as to enable those skilled in the art to understand and practice the same, and the generic principles described herein can be applied to other embodiments without departing from the spirit or scope of this disclosure. Thus, it is to be understood that the description and drawings presented herein represent a presently preferred embodiment of the subject matter and are therefore representative of the subject matter which is broadly contemplated by the present disclosure.

1. A rack system for growing crops, comprising:
a first stand and a second stand;
a base supporting the first stand and the second stand, the first stand arranged opposite the second stand;
at least one tray holder positioned on each of the first and second stands;
at least one rack tray comprising a plurality of attachment points at opposite ends of the at least one rack tray, the attachment points configured for tilting the at least one rack tray to a plurality of predetermined angles; and
attachment means attaching the at least one rack tray to the at least one tray holder through the attachment points.

2. The rack system according to claim 1, wherein the attachment means comprise hangars suspending the rack tray from the at least one tray holder positioned on the first and second stands.

3. The rack system according to claim 2, wherein:
the attachment points comprise a plurality of notches on the sides of the tray;
at least a pair of anchor hooks attached on the opposite sides of the tray to at least one of each of the plurality of notches;
each notch is selected to tilt the rack tray to one of the predetermined plurality of angles; and
each of the hangars attach to one of the notches with anchor hooks and the at least one tray holders.

4. The rack system according to claim 3, wherein the hangars comprise a hook end and an attachment end.

5. The rack system according to claim 1, wherein the at least one tray holder comprises a center bar extending between the first stand and the second stand.

6. The rack system according to claim 1, wherein the base optionally comprises a plurality of wheels.

7. The rack system according to claim 1, wherein each of the first stand and the second stand comprise a diagonal support and a substantially vertical support.

8. The rack system according to claim 1, wherein the first and second stands further comprise extension pieces for incorporating additional rack trays and additional stands.

9. The rack system according to claim 1, further optionally comprising an irrigation system, and the rack tray further optionally comprise attachments for irrigation pipe connections.

10. The rack system according to claim 1, further optionally comprising other irrigation systems like sprinkler system, boom irrigation, etc.

11. The rack system according to claim 1, wherein the first and second stands are configured to mount onto existing urban or unutilized spaces or over water bodies.

12. The rack system according to claim 1, wherein the first and second stands are height adjustable.

13. The rack system according to claim 1, wherein the rack trays, first and second stands, hangars, are pre-fabricated single or multiple pieces attached together.

14. A rack system (10) for growing crops, comprising:
a first inverted V-stand (20) and a second inverted V-stand (30), the first and second inverted V-stands each comprising a diagonal support (22, 32) and a substantially vertical support (24, 34);
a base (40) supporting the first inverted V-stand (20) and the second inverted V-stand (30), the first inverted V-stand (20) arranged at an end opposite the second inverted V-stand (30);
at least one tray holder (50) extending between the diagonal support (22) of the first inverted V-stand (20) and the diagonal support (32) of the second inverted V-stand (30);
at least one growing rack tray (60) comprising a plurality of tilting notches (64, 65, 66, 67, 68, 69) at opposing ends (61, 62);
at least a pair of anchor hooks (70, 72) attached to at least one of the tilting notches at each opposing end (61, 62) of the at least one elongated growing rack tray (60); and
at least a pair of hangars, each comprising an anchor attachment (82, 87) and a hangar hook (84, 89), each of the anchor attachments (82, 87) attached to the anchor hooks (70, 72) and each of the hangar hooks (84, 89) suspending the at least one growing rack tray from the at least one tray holder (50),
wherein the plurality of tilting notches (64, 65, 66, 67, 68, 69) at the opposing ends (61, 62) of the at least one growing rack tray (60) are configured to tilt the at least one growing rack tray to a plurality of predetermined angles.

15. A method of growing crops, comprising:
providing a rack system for growing the crops, the rack system comprising: a first stand, a second stand, a base, and at least one tray holder positioned on each of the first and second stands, wherein the base supports the first stand opposite the second stand;
providing at least one rack tray, the at least one rack tray comprising a plurality of attachment points at opposite ends of the at least one rack tray, the attachment points configured for tilting the at least one rack tray to a plurality of predetermined angles;
attaching the at least one rack tray to the at least one tray holder by way of attachment means; and
tilting the at least one rack tray to a predetermined angle to provide additional sunlight to the rack tray and space to growing plant.

16. The method according to claim 14, further comprising: positioning the rack system along the center bar in an east-west direction.
